(19) United States
(12) Patent Application Publication
(10) Pub. No.: US 2020/0294147 A1
(43) Pub. Date: Sep. 17, 2020

(54) ARTIFICIALLY INTELLIGENT RETIREMENT INCOME PLANNER

(71) Applicant: CASCADES FINANCIAL SOLUTIONS INC., Ingersoll (CA)

(72) Inventors: Ian Clarke MOYER, Ingersoll (CA); Jonathan Peter KESTLE, Ingersoll (CA)

(21) Appl. No.: 16/579,127

(22) Filed: Sep. 23, 2019

(30) Foreign Application Priority Data
Mar. 13, 2019 (CA) 3036534

(51) Int. Cl. G06Q 40/06; G06N 5/02

(52) U.S. Cl. CPC G06Q 40/06; G06N 5/025

(57) ABSTRACT

An artificially intelligent retirement income planning computing engine and methods for determining and documenting a withdrawal plan for a person who has multiple income sources. The computing engine has a data collection module to electronically receive a specification of cash flow receivable by the person from the income sources and a calculation module configured to employ multiple strategies employs rules-based artificial intelligence techniques to achieve a maximum or a pre-determined after-tax income that can be obtained by the person from the income sources during the person's retirement.

### FIELD OF THE INVENTION

The present invention relates generally to financial services, and more particularly, to an artificially intelligent retirement income planning computing engine for determining and documenting a withdrawal plan for a person having a plurality of income sources, a life expectancy date and a retirement date.

### BACKGROUND OF THE INVENTION

This invention relates generally to financial services and products, and more particularly to financial systems that implement a retirement consumption strategy that provides an investor with exposure to markets for a period of time and lifetime payments thereafter.

There remains a gap that has not yet been sufficiently addressed in the retirement income space Annuities, or various investments having similar properties, that maximizes a client's lifetime payments. Other products in this space either 1) use a single strategy for drawdown and savings that all plans must follow, or 2) requires that the user provide a priority of accounts to draw down income for the plan. Both strategies are limited in that there is no capacity for a hybrid drawdown strategy that would take draw from multiple assets in tandem. What is needed, therefore, is a product that designs a retirement plan based on multiple retirement strategies but also provides for a hybrid approach that maximizes a client's income over their retirement period.

### SUMMARY OF THE INVENTION

The invention provides an artificially intelligent retirement income planning computing engine for determining and documenting a withdrawal plan for a person having a particular life expectancy, retirement date and multiple income sources. The income sources include (a) a pension, (b) registered savings having a base withdrawal plan requiring that pre-determined minimum amounts be withdrawn by particular dates, (c) non-registered savings, and (d) a line of credit. The income sources may also include tax-free savings having a value.

The computing engine has a data collection module, a calculation module and optionally an intelligent recommendations module. The modules comprise a computer processor for receiving information, performing calculations and generating reports.

The data collection module is configured to electronically receive a specification of cash flow receivable by the person from the pension, a value of the registered savings, and a value of the non-registered savings.

The calculation module is configured to use at least two strategies and may be configured to use a third or more. Each strategy used by the calculation module employs a rules-based artificial intelligence technique which includes an ordered set of rules for withdrawing funds from the income sources. The calculation module applies the rules according to one of the strategies by applying the rules of the particular strategy in the specified order until sufficient funds are withdrawn at each withdrawal date to achieve the maximum or the pre-determined after-tax income.

Using the first strategy, the calculation module is configured to calculate a first withdrawal plan to achieve maximum or a pre-determined after-tax income that can be obtained by the person from the income sources during an income period starting at the person's retirement date and ending at a report end date that is a pre-determined amount of time after the person's life expectancy date. The income period of the first withdrawal plan is subdivided into a sequence of withdrawal dates, and a non-negative first life expectancy net estate value resulting from the first withdrawal plan at the person's life expectancy date. The first rule of this strategy may be to withdraw funds from the registered savings evenly from the retirement date until a pre-determined amount of time relative to the life expectancy date. Uneven withdrawal may alternatively be employed.

Using a second strategy, the calculation module is configured to calculate a second withdrawal plan that results in the maximum or the pre-determined after-tax income being obtained during the withdrawal period, a second report end net estate value resulting from the second withdrawal plan at the report end date and a second life expectancy net estate value resulting from the second withdrawal plan at the person's life expectancy date. The first rule of this strategy may be to withdraw funds from registered savings according to the base withdrawal plan.

Using a third strategy, the calculation module is configured to calculate a third withdrawal plan that results in the maximum or the pre-determined after-tax income being obtained during the withdrawal period, a third report end net estate value resulting from the third withdrawal plan at report end date, and a third life expectancy net estate value resulting from the third withdrawal plan at the person's life expectancy date.

The intelligent recommendations module is configured to analyze a withdrawal plan produced by the selected strategy to identify actions that can be taken by the person in order to increase the maximum after-tax income or the life expectancy net estate value. The intelligent recommendations module may additionally be configured to ease the administration of the estate and ease the administration of the administration of the withdrawal plan.

The computing engine selects the strategy providing the greatest life expectancy net estate value having a non-negative report end net estate value. Once selected, the computing engine generates a report documenting the withdrawal plan produced by the selected strategy.

The computing engine is preferably a computer system including one or more computer processors running software. The computer system may include multiple computer sub-systems, each including one or more computer processors. For example, each module may be a separate computer system. In some embodiments, the computing engine may employ only a single computer processor. The processing described herein is preferably implemented in software running on the one or more computer processors.

### BRIEF DESCRIPTION OF THE DRAWINGS

FIG. 1 is a system overview of an illustrative computer system used in the practice of the invention.

FIG. 2 is a diagram of a basic structure of the relationships among the actors in a retirement consumption strategy, in accordance with an embodiment of the invention.

FIG. 3 is a flowchart of a process for implementing a managed retirement consumption strategy.

FIG. 4 is a flowchart illustrating the process by which the maximum retirement income is calculated

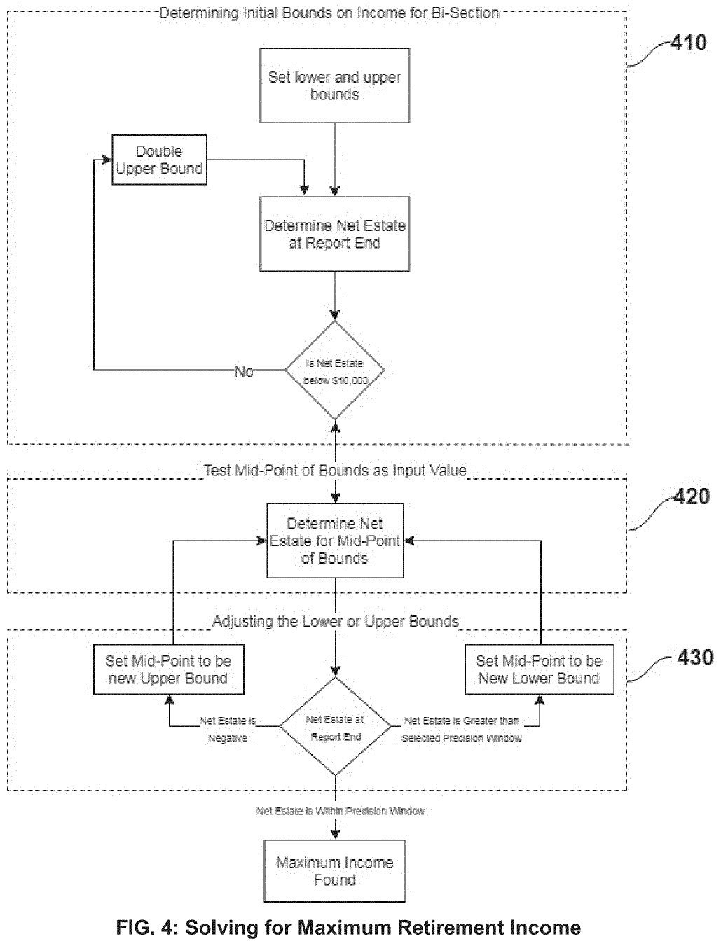

FIG. 5 is a flowchart illustrating the planning strategy as applied by the invention.

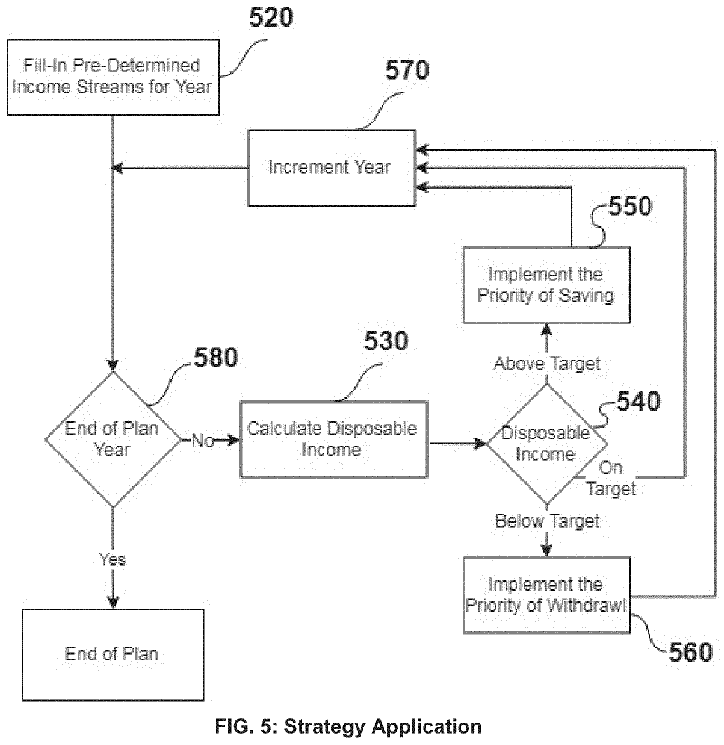

### DETAILED DESCRIPTION OF THE INVENTION

The present invention is described as it applies to its preferred embodiments. It is not intended that the present invention be limited to the described embodiments. It is intended that the invention cover all modifications and alternatives which may be included within the spirit and broad scope of the invention.

The preferred embodiment is directed to a computing engine for designing and documenting a retirement plan which compares three of the most effective and common investment drawdown strategies. Those skilled in the art will recognize that the system and methods disclosed as part of the preferred embodiment can be easily adapted for other types of investment drawdown strategies.

The preferred embodiments described herein focus on income sources/products available in Canada, but the invention is not so limited. For example, the invention can be configured for use in the United States of America, as discussed below (“Adapting Strategies for Different Markets”)

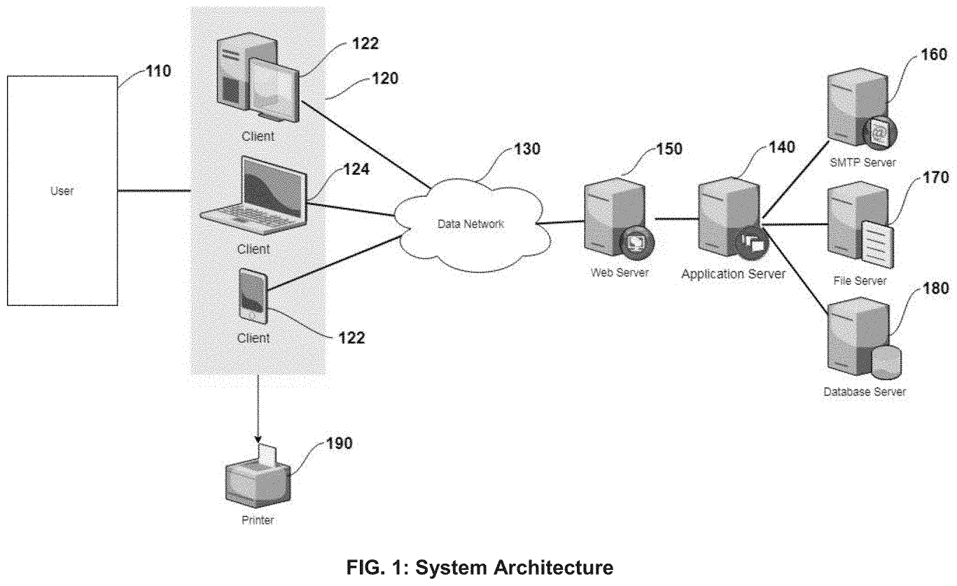

FIG. 1 illustrates an embodiment of an architecture providing an online based system for graphically representing retirement plan based on income information from a plurality of investment and income sources associated with a user. The architecture comprises a user 110, a client device 120, a data network 130 and an application server 140.

The user can use a client device to interact with the server over the data network. The client computer may comprise a computing element, a display, and possibly one or more other output devices, and one or more input devices such as a keyboard, a mouse, a trackball, a microphone or a touch sensitive display. In various embodiments, the client device may be a desktop computer 122, laptop computer 124, tablet computer 126 or another computing device having computing functionality and access to the data network. The application may be implemented and served to client devices by using a combination of hardware and software which may include a web server 150, application server, mail server 160, file server 170 and database server 180. The servers need not be separate physical devices and may be implemented in software on a single computing device. The client device may also be connected to a printer 190.

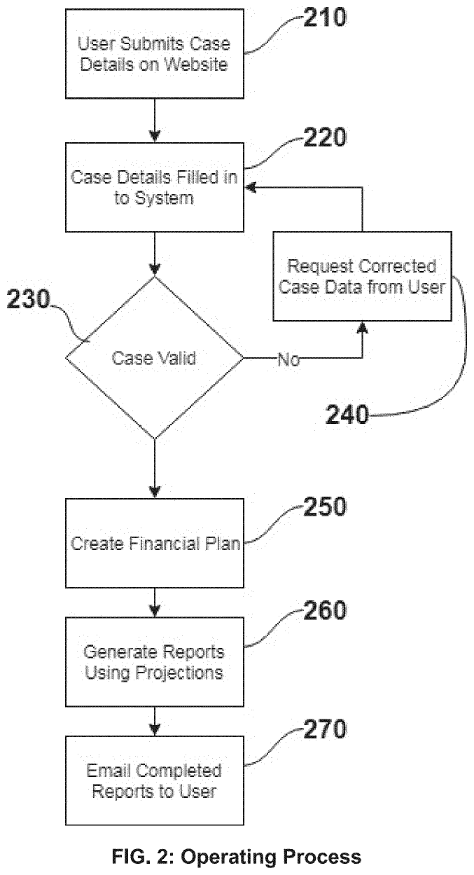

FIG. 2 illustrates how a user would generally interact with the architecture to operate the system to create and document a retirement plan.

### User Submits Case Details

The planning process first begins by the user accessing the application using the online based system using a client device. The user is presented with a graphical user interface (GUI) by which they may submit details for the case they wish to analyze 210. In a preferred embodiment, the GUI is implemented through the Contact Form 7 Plug-In for WordPress and sends an email of the data to the individual or organization in order to process the case.

In this preferred embodiment, the user is first authenticated using a username and password to prove identity and access the system. Once authenticated, the user is presented with the home screen and is provided the option to enter a new case. The user is prompted to enter information relating to their case including:
whether the report relates to a single or couple;
client information such as the any names, date(s) of birth, and other demographic information;
financial information such as participation in and the value of any retirement plans, accounts, etc.;
eligibility information for government programs such as the Canada Pension Plan;
custom (or undefined) income sources that are not otherwise identified;
any one-time lump sum plan contributions;
investor risk profile or tolerance; and
any additional income withdrawals required during retirement.

### Case Details Filled in to Retirement Income Planning System

Details for the case may also be filled into an Excel worksheet that mirrors the online user form 220. In the preferred embodiment, Visual Basic for Applications is used to load the system with proper numerical data based on answers supplied by the user.

### Valid Case Verification Stage

The online based system validates the user input 230. If any of the fields entered are identified by the online system as being problematic the fields are highlighted and the user is presented with an error message explaining the problem.

In the case where an invalid input cannot be identified and corrected by the online system, the service provider is to follow up with the user and obtain correct information.

The online system also verifies if the user is an existing customer based on their email address. If the user is a past customer, then the system moves the case to the appropriate directory for them and the given clients. If they are not an existing customer the appropriate file hierarchy is created to store details for this user, their clients, and the individual cases for each client.

Request Corrected Case Data from User

The online system may be configured to request corrected case data by email. The email is sent to the user's provided email address and identifies any problem with the user supplied data along with an explanation and any suggested changes to the case data that may be made in order to resolve the issue 240. Upon receiving updated case data, the system updates the case with the corresponding changes and reflects these updates through the GUI. Any changes to case data are then re-verified by the system to ensure validity.

### Create Retirement Income Financial Plan

With valid case data confirmed, the system can commence projections and calculations for the financial plan.

The planning process compares three of the most effective and common investment drawdown strategies at the requested retirement income level. This requested retirement income level may be a specific amount provided by the user or simply a request to solve for the maximum sustainable retirement income 250.

### Generate PDF Reports Using Projections

The planning process uses the data contained in the projections tables to generate the final reports. The process will post selected summary data to report worksheets, build charts, write recommendations and format worksheet content. Report worksheets are exported to a PDF and saved in the appropriate directory for the client, user and case 260.

The report includes information summarizing:
provided client information
considered income strategies;
net-estate under each strategy; and
income information for each strategy.

Additionally the report provides detailed information such as a detailed income and detailed savings ledger. These ledgers specify the client's account information under the selected strategy for each year.

### Email Completed Reports to User

A personalized email message is generated and sent to the provided email address for the user with completed reports as attached PDFs. Two files are sent—a summary copy and master copy of the report. The files are identical aside from the complete calculation ledgers contained at the end of the master copy 270.

### 2. Planning Process

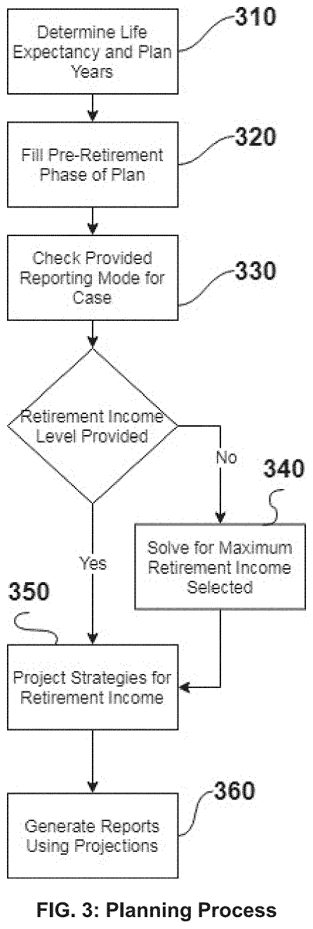

FIG. 3 depicts the planning process which can broadly be described to produce a graphical representation of a retirement plan by:
Determining life expectancy and end of plan years 310;
Completing pre-retirement phase of the plan 320;
Identifying the reporting mode 330;
Solving for maximum retirement income (if retirement income is not provided) 340;
projecting income strategies 350; and
generating reports 360.

### Determine Life Expectancy and End of Plan Years

The planning process begins by determining client life expectancy based on their current age and sex using the Society of Actuaries Annuity 2000 Basic Table. For couples, the joint last-to-die expectancy is used. If the sex of a client is not recorded, the process assumes that the client is female. This results in the selection of a more conservative income drawdown strategy since females have a longer life expectancy.

The planning process sets the end of plan year to 15 years after life expectancy for a single and 10 years after joint last-to-die life expectancy for a couple.

### Completing Pre-Retirement Phase of Plan

The planning process projects savings contributions, employment income and any other provided source of income for the client(s) up until their retirement age (or later of 2 retirement dates for a couple).

For a couple with different retirement dates, the planning process has a “semi-retirement” phase where one spouse continues to work and another is retired. In this situation, an even drawdown of the retired spouse's registered assets is projected (as in the “Registered Funds First” strategy) to obtain a list of disposable incomes in each year of this semi-retirement phase to use as the income target under other strategies.

### Identifying the Reporting Mode

The planning process then checks for the case mode selected by the user. The user may select to have the process illustrate a drawdown strategy for a pre-determined disposable income level in retirement or a solution for the “maximum” disposable income in retirement.

In either case the process will project a level (adjusted to inflation) disposable income during each year of the retirement phase of the plan.

### Solving for Maximum Retirement Income

The planning process uses a bisection method in order to determine the “maximum” level (inflation adjusted) disposable income amount that is attainable each year of the retirement phase up to the end of plan year. The process considers the “maximum” disposable income to be found in this bisection when a tested value for level disposable income provides a net estate value between $0 and $10,000 in the end of plan year.

The planning process performs this bisection first with the “Registered Funds First” strategy to obtain a maximum sustainable retirement income level and then re-create this income level under all other strategies, posting summary information for each strategy along the way in order to determine a winner.

The winner is chosen as the strategy that (a) maximizes net estate value in the life expectancy year and (b) also provides a positive net estate value in the end of plan year. By design, the initial tested strategy is guaranteed to satisfy criterion (b) so a winner meeting these criteria can always be chosen.

### Projecting Income Strategies

If the user provided a disposable income level in retirement to illustrate, the process simply fills in the projections to the end of plan year under each of the strategies. The winning strategy is chosen as the one that provides the highest net estate value in the life expectancy year.

If the process solved for the maximum retirement income, then the strategy that was selected to achieve the max retirement income is depicted.

### Generate PDF Reports Using Projections

Charts, written recommendations and milestone years are based on user-provided values and calculated values from the data ledgers for the winning strategy.

Summary information from each of the losing strategies is stored and used to build the scenario comparison page of the report to demonstrate that multiple strategies are being compared against each other.

The projections for the winning strategy then form the basis for the remainder of the report once the best strategy is identified to the user.

### 3. Solving for Max Retirement Income

### Logic and Setup to Solve for Maximum Income

The planning process considers the projected net estate value in the end of plan year as a function of the inflation-adjusted disposable income level that it creates in each year of retirement.

The process takes advantage of the fact that net estate value in the final year is a continuous and monotonically decreasing function of the disposable income level in retirement (i.e. If someone takes a “little” more income to spend in each year of retirement they will have a “little” less money left at the end of their life.) This means that there is a unique disposable income level that will provide exactly $0 in net estate at report end.

The process uses bisection to zero-in on the income level that perfectly depletes the net estate at report end. In the interest of run time, the process does not solve for the income that gives exactly (within machine precision) $0 in net estate at report end, but rather, is content to find an income that provides a nominally small (positive) net estate value at report end. The process chooses between a precision window size of $0-$10,000. The choice of window size is all a trade-off between desired precision and run time.

Thus the choice of root-finding algorithms is somewhat limited for the process. Bisection has guaranteed convergence and good worst-case performance. However, other methods like the Regula Falsi and Brent-Dekker methods could alternatively be used to provide better average-case performance.

FIG. 3 depicts the process by which the Maximum Retirement Income is calculated. The process generally operates by:
1. determining the initial bounds on income for bisection 410;
2. testing the mid-point of bounds as input value 420;
3. adjusting the lower or upper bounds and repeating step 2 until net estate is within selected precision window 430.

### Determine Initial Bounds on Income for Bisection

The lower bound on the input (disposable income) for bisection is trivially $0 as any income stream in retirement or investment account will result in money left over at the end when no income is being used throughout retirement for lifestyle spending.

The upper bound for the input needs to be determined still. The process starts with $100,000 and then observe the net estate value at report end. If end net estate value is greater than $10,000 (or whatever chosen precision window for “exact” depletion) then we double this upper bound until we find one that gives us a net estate value below $10,000 at report end.

### Test Mid-Point of Bounds as Input Value

The planning process uses the mid-point (average) of the upper and lower bounds as the disposable retirement income level and determines resulting net estate value at report end when this mid-point is used.

There are 3 potential outcomes for the net estate value at report end:
I. Net estate value at report end is greater than $10,000 (or selected precision window);
II. Net estate value at report end is negative; or
III. Net estate value at report end is between $0 and $10,000 (or selected precision window)

A negative net estate at report end is created by an income level that requires a line of credit or other debt to be generated once all investments are depleted.

### Set New Lower Bound to be Mid-Point

The process sets the new lower-bound for bisection to be the mid-point that provided a net estate value above $10,000 (or selected precision window) at report end. The upper bound remains the same as before. The process returns these new bounds on disposable income to observe the net estate at report end of their mid-point knowing that the “exact” solution still exists in this new interval which is half the size of the previous interval.

The process sets the new upper-bound for bisection to be the mid-point that provided a negative net estate value at report end. The lower bound remains the same as before. The process returns these new bounds on disposable income to observe the net estate at report end of their mid-point knowing that the “exact” solution still exists in this new interval which is half the size of the previous interval.

### Maximum Income Found for the Strategy at Hand

The maximum or “max” income is found once the last observed disposable income level provides for a net estate at report end with a value that falls between $0 and $10,000 (or selected precision window). This is the “max” income for the strategy at hand; the process can now compare this income level across strategies.

### 4. Strategy Application & Descriptions

### Strategy Application

In developing the retirement plan, the artificial intelligence compares multiple strategies to make a recommendation for the priority to draw down funds. These strategies are based on three common strategies in the retirement income planning space:
(I) ‘Registered Funds’ first is very conscious of income taxes on registered funds on death and looks to minimise this by drawing down these funds evenly prior to life expectancy.
(II) ‘Non-Registered Funds First’ looks to maximize tax-free market returns by relying on non-registered funds primarily for additional income and then registered funds but without enforcing a drawdown of registered funds by life expectancy.
(III) ‘Tax Free Funds First’ looks to maximize the gross assets held by the client and thus the total market return they achieve by deferring the registered assets to the very end.

### Fill-in Pre-Determined Income Streams for Year

The process sets the values for any pre-determined income streams as provided by the user (e.g. pension payments, Canadian Pension Plan payments, Old Age Security payments, annuities, custom income sources and minimum registered payments) 510.

Next, the process calculates taxable income, taxes payable and disposable income, comparing the disposable income to our target disposable income in retirement (either given by user or part of an iteration as we solve for “max” disposable income in retirement) 520. The observed disposable income will either be above, below or at the target disposable income 540.

For a couple, the process runs an income-splitting algorithm here to find max disposable income as a couple iterating over splittable pension income sources for each spouse to do so.

### Observed Disposable Income Above Target

The process, when observing a disposable income level above target in the previous year, needs to save money to achieve the target value. In order to do so, the process implements its priority of saving for the strategy at-hand 550.

### Observed Disposable Income Below Target

The process, when observing a disposable income below target in the previous year, needs to withdraw money to achieve the target value. In order to do so, the process will implement its priority of withdrawal for the strategy at-hand 560.

### Disposable Income Target Achieved

Once the process has solved the disposable income target for the year. For a single individual, the process is done and proceeds to the next year. For a couple, if the taxable income amount for either spouse has changed since filling pre-determined incomes, the process runs the income-splitting algorithm again as there may be a possible disposable income increase. The process then recontributes any increase in disposable income to savings per given strategy's priority so it is still at the income target. Once any recontribution occurs, the process then proceeds to next year 570.

### Continue Looping Until End of Plan Year

The process repeats itself for each year of the plan 580.

### Strategies

The process tests multiple drawdown strategies in order to maximize the client's retirement income. Each drawdown strategy attempts to maximize this income through different mechanisms such as minimizing taxes paid or maximizing investment returns. The following strategies are employed by the planning process.

### Registered Funds First

The Registered Funds First strategy looks to decrease risk of taxation in the estate by evenly drawing down registered retirement income fund (RRIF) funds from initial retirement age to 5 years prior to life expectancy, and evenly drawing life income funds (LIF) to deplete by age 90. In some embodiments the withdrawals may be uneven. This strategy therefore uses imposed RRIF and LIF payments during these phases. Funds are invested and withdrawn according to the following priority schemes:

Savings Priority: The Registered Funds First strategy prioritizes its savings by contributing to the individual or couple's accounts in the following order:

1. line of credit (up to balance owing);

2. tax-free savings account (TFSA) (up to contribution limit); and

3. non-registered savings.

Under this strategy, any non-registered savings are shifted to a tax free savings account each year up to limit.

Withdrawal Priority: The Registered Funds First strategy prioritizes its withdrawals by drawing from the individual or couple's accounts in the following order:

1. imposed RRIF and LIF payments;

2. non-registered savings (joint then personal for a couple);

3. tax-free savings accounts;

4. LIF money above imposed payment (up to LIF max);

5. RRIF money above imposed payment; and

6. line of credit.

### Non-Registered Funds First

The Non-Registered Funds First strategy looks to defer registered savings somewhat in order to take advantage of the tax-free return as much as possible, but is mindful not to leave registered funds to the end of life—risking a large estate tax bill—when a tax free savings account can also provide the same tax-free investment return. Funds are invested and withdrawn according to the following priority schemes:

Savings Priority: The Non-Registered Funds First strategy prioritizes its savings by contributing to the individual or couple's accounts in the following order:

1. line of credit (up to balance owing);

2. tax-free savings account (up to contribution limit); and

3. non-registered savings.

Under This strategy, any non-registered savings are shifted to a tax free savings account each year up to limit.

Withdrawal Priority:

The Non-Registered Funds First strategy prioritizes its withdrawals by drawing from the individual or couple's accounts in the following order:

1. minimum RRIF and LIF payments;

2. non-registered savings (joint then personal for a couple);

3. LIF money above minimum (up to LIF max);

4. RRIF money above minimum;

5. tax-free savings accounts; and

6. line of credit.

### Tax-Free Funds First

The Tax-Free Funds First strategy looks to maximize the gross assets held by the client and thus market return they achieve by deferring drawdown of assets that have tax-free market returns. It therefore takes non-registered assets first then tax free savings accounts and registered assets above the minimum as a last priority. Funds are invested and withdrawn according to the following priority schemes:

Savings Priority: The Tax-Free Funds First strategy prioritizes its savings by contributing to the individual or couple's accounts in the following order:

1. line of credit (up to balance owing);

2. tax-free savings account (up to contribution limit); and

3. non-registered savings.

The Tax-Free Funds First strategy does not actively shift Non-Registered Savings to a tax free savings account.

Withdrawal Priority: The Tax-Free Funds First strategy prioritizes its withdrawals by drawing from the individual or couple's accounts in the following order:

1. minimum RRIF and LIF payments;

2. non-registered savings (joint then personal for a couple);

3. tax-free savings accounts;

4. LIF money above minimum (up to LIF max);

5. RRIF money above minimum; and

6. line of credit.

### Adapting Strategies for Different Markets

The United States of America (US), much like Canada, has created a number retirement specific investment accounts with certain tax advantages. These US investment accounts, although in many respects identical to their Canadian counterparts, have some differences. However, these differences do not materially change the underlying methodology for determining maximum retirement income, determining maximum net estate for a given retirement income or choosing a winning strategy based on previously described strategies.

Government Pensions: The US Social Security (OASDI) is roughly equivalent to the Canadian Pension Plan (CPP). The primary difference being that OASDI can be started from age 62 to 67; whereas CPP can be started from age 60 to 70. The rate at which OASDI payments decrease for early withdrawal differs from CPP but this difference can readily be accounted for by a simple substitution of parameter values. Similarly, both OASDI and CPP are funded by a combination of employee and employer contributions at a set rate up to a set annual limit.

Canada's Old Age Security (i.e. Canada's government funded income supplement for all individuals above a certain age) has no equivalent in the US system. However, the US does have Supplemental Security Income (SSI) that is similar to Canada's Guaranteed Income Supplement (GIS) which provides funds to individuals aged 65 and over with income below a certain threshold.

Defined Benefit Pensions: Income from defined benefit pensions in Canada and the US are treated identically by each of the strategies. However, there does not exist any federal pension credits for pension income in the US which must be accounted for. This can be accomplished by removing the credits from any calculations or simply setting the credit rate parameter to 0.

Registered Savings: Registered Retirement Savings Plans, RRIFs, defined contribution pensions or groups, LIFs, US IRAs and 401k plans are very similar in terms of tax administration; contributions can be deducted from income while working, annual contributions are capped, market returns are tax-free, and tax is paid on the income that comes out of the plan during retirement. There are differences between these plans but these differences can be easily accounted for by adapting some simple calculations. The key differences are that:
a US IRA/401k has a penalty if the individual withdraws funds before the age of 60 whereas no such penalty exists in Canada (to adapt the strategies for the US, the planning process would simply not use a 401 k for income for persons aged less than 60 unless it was the only option;
a US 401k allows for contributions at a flat rate each year (currently $17,500 for individuals under the age of 50 and $23,000 individuals aged 50 or over) whereas RRSP contribution space is 18% of employment income capped at $26,230 per year; and
unused 401k contribution space does not carry forward year-to-year whereas RRSP contribution space does.

Non-registered savings: Differences in how non-registered savings are treated can be accounted for by simply using the US tax rules for gross-up and gross-down on capital gains and dividends in place of the Canadian rules. The calculations are different but the function of the account within the planning process remains the same.

Tax-Free Savings: The US equivalent of the Canadian TFSA is the Roth IRA. Both the TFSA and Roth IRA are funded with after-tax income and generally have tax-free returns. The key differences between the two accounts are that:
Roth IRA returns are taxable if withdrawn prior to age 60 or within 5 years of account establishment (no equivalent rules for a TFSA);
Unused contribution room carries forward year-to-year with a TFSA but not with a Roth IRA; and
Roth IRA contribution room depends on the individual's age (extra for those 50+) and income that for the year (phases out past a certain income) whereas TFSA contribution room for any given year is the same for everyone.

It will be evident to skilled persons that the approach described herein can be adapted to other countries based on comparable or similar income sources/products available in those jurisdictions.

The specifics of the products described herein are based on what exists as of the filing date of this application.

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile, non-transitory, computer-readable memory that may be used to distribute or sell embodiments of the invention or parts thereof.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

1. An artificially intelligent retirement income planning computing engine for determining and documenting a withdrawal plan for a person having a plurality of income sources, the income sources including (a) a pension, (b) registered savings having a base withdrawal plan requiring that pro-determined minimum amounts must be withdrawn by particular dates, (c) non-registered savings, and (d) a line of credit, the person having a life expectancy date and a retirement date, the computing engine comprising:
a data collection module configured to electronically receive a specification of cash flow receivable by the person from the pension, a value of the registered savings, and a value of the non-registered savings;
a calculation module configured to:
using a first strategy, calculate (e) a first withdrawal plan to achieve maximum or a pre-determined after-tax income that can be obtained by the person from the income sources during an income period starting at the person's retirement date and ending at a report end date that is a pre-determined amount of time after the person's life expectancy date, with a non-negative first report end net estate value resulting from the first withdrawal plan at the report end date, the income period being subdivided into a sequence of withdrawal dates, and (f) a first life expectancy net estate value resulting from the first withdrawal plan at the person's life expectancy date;
using a second strategy, calculate (g) a second withdrawal plan for withdrawing funds from each income source at each withdrawal date that results in the maximum or the pre-determined after-tax income being obtained during the withdrawal period; (h) a second report end net estate value resulting from the second withdrawal plan at the report end date; and (i) a second life expectancy net estate value resulting from the second withdrawal plan at the person's life expectancy date;
select the strategy with a non-negative report end net estate value that provides the greatest life expectancy net estate value;
generate a report documenting the withdrawal plan produced by the selected strategy,
wherein the data collection module and the calculation module comprise a computer processor for receiving information, performing calculations and generating the report,
wherein each strategy employs a rules-based artificial intelligence (AI) technique comprising an ordered set of rules for withdrawing funds from the income sources, each rule specifying how much to withdraw from each income source, and wherein the calculation module applies the rules of one of the strategies by applying the rules of that strategy in the specified order until sufficient funds are withdrawn at each withdrawal date to achieve the maximum or the pre-determined after-tax income.

2. The artificially intelligent retirement income planning computing engine of claim 1, further comprising an intelligent recommendations module configured to analyze the withdrawal plan produced by the selected strategy to identify actions that can be taken by the person in order to increase the maximum after-tax income or the life expectancy net estate value.

3. The artificially intelligent retirement income planning computing engine of claim 2, wherein the intelligent recommendations module is further configured to identify actions that can be taken by the person in order to ease the administration of the estate.

4. The artificially intelligent retirement income planning computing engine of claim 2, wherein the intelligent recommendations module is further configured to identify actions that can be taken by the person in order to ease the administration of the administration of the withdrawal plan.

5. The artificially intelligent retirement income planning computing engine of claim 1, wherein the calculation module is further configured to use a third strategy to calculate (a) a third withdrawal plan that results in the maximum or the pre-determined after-tax income being obtained during the withdrawal period; (b) a third report end net estate value resulting from the third withdrawal plan at report end date; and (c) a third life expectancy net estate value resulting from the third withdrawal plan at the person's life expectancy date.

6. The artificially intelligent retirement income planning computing engine of claim 1, wherein the first rule of the first strategy is to withdraw funds from the registered savings evenly from the retirement date until a pre-determined amount of time relative to the life expectancy date, or until a pre-determined age of the person, and the first rule of the second strategy is to withdraw funds from registered savings according to the base withdrawal plan.

7. The artificially intelligent retirement income planning computing engine of claim 1, wherein the income sources further include tax-free savings having a value.

8. An artificially intelligent retirement income planning computing engine for determining and documenting a withdrawal plan for a person having a plurality of income sources, the income sources including (a) a pension, (b) registered savings having a base withdrawal plan requiring that pre-determined minimum amounts must be withdrawn by particular dates, (c) non-registered savings, and (d) a line of credit, the person having a life expectancy date and a retirement date, the computing engine comprising:
a data collection module configured to electronically receive a specification of cash flow receivable by the person from the pension, a value of the registered savings, and a value of the non-registered savings;
a calculation module configured to:
using a first strategy, calculate a first withdrawal plan to achieve a first maximum after-tax income that can be obtained by the person from the income sources during an income period starting at the person's retirement date and ending at a report end date that is a pre-determined amount of time after the person's life expectancy date, with a non-negative first report end net estate value resulting from the first withdrawal plan at the report end date, the income period being subdivided into a sequence of withdrawal dates;
using a second strategy, calculate a second withdrawal plan to achieve a second maximum after-tax income that can be obtained by the person from the income sources during the income period, with a non-negative second report end net estate value resulting from the second withdrawal plan at the report end date;
select the strategy that achieves the greatest maximum after-tax income;
generate a report documenting the withdrawal plan produced by the selected strategy,
wherein the data collection module and the calculation module comprise a computer processor for receiving information, performing calculations and generating the report,
wherein each strategy employs a rules-based artificial intelligence (AI) technique comprising an ordered set of rules for withdrawing funds from the income sources, each rule specifying how much to withdraw from each income source, and wherein the calculation module applies the rules of one of the strategies by applying the rules of that strategy in the specified order until sufficient funds are withdrawn at each withdrawal date to achieve the maximum after-tax income.

9. The artificially intelligent retirement income planning computing engine of claim 8, wherein the calculation module is further configured to use a third strategy to calculate a third withdrawal plan to achieve a third maximum after-tax income that can be obtained by the person from the income sources during the income period, with a non-negative second report end net estate value resulting from the third withdrawal plan at the report end date.

10. An artificially intelligent retirement income planning method for determining and documenting a withdrawal plan for a person having a plurality of income sources, the income sources including (a) a pension, (b) registered savings having a base withdrawal plan requiring that pre-determined minimum amounts must be withdrawn by particular dates, (c) non-registered savings, and (d) a line of credit, the person having a life expectancy date and a retirement date, the method comprising:
electronically receiving a specification of cash flow receivable by the person from the pension, a value of the registered savings, and a value of the non-registered savings;
calculating:
using a first strategy, (e) a first withdrawal plan to achieve maximum or a pre-determined after-tax income that can be obtained by the person from the income sources during an income period starting at the person's retirement date and ending at a report end date that is a pre-determined amount of time after the person's life expectancy date, with a non-negative first report end net estate value resulting from the first withdrawal plan at the report end date, the income period being subdivided into a sequence of withdrawal dates, and (f) a first life expectancy net estate value resulting from the first withdrawal plan at the person's life expectancy date;
using a second strategy, (g) a second withdrawal plan for withdrawing funds from each income source at each withdrawal date that results in the maximum or the pre-determined after-tax income being obtained during the withdrawal period; (h) a second report end net estate value resulting from the second withdrawal plan at the report end date; and (i) a second life expectancy net estate value resulting from the second withdrawal plan at the person's life expectancy date;
selecting the strategy with a non-negative report end net estate value that provides the greatest life expectancy net estate value;
generating a report documenting the withdrawal plan produced by the selected strategy,
wherein the method uses a computer processor for receiving information, performing calculations and generating the report,
wherein each strategy employs a rules-based artificial intelligence (AI) technique comprising an ordered set of rules for withdrawing funds from the income sources, each rule specifying how much to withdraw from each income source, and wherein the method applies the rules of one of the strategies by applying the rules of that strategy in the specified order until sufficient funds are withdrawn at each withdrawal date to achieve the maximum or the pre-determined after-tax income.

11. The artificially intelligent retirement income planning method for determining and documenting a withdrawal plan for a person having a plurality of income sources of claim 10, further analyzing the withdrawal plan produced by the selected strategy to identify actions that can be taken by the person in order to increase the maximum after-tax income or the life expectancy net estate value.

12. The artificially intelligent retirement income planning method for determining and documenting a withdrawal plan for a person having a plurality of income sources of claim 10, wherein the method further identifies actions that can be taken by the person in order to ease the administration of the estate.

13. The artificially intelligent retirement income planning method for determining and documenting a withdrawal plan for a person having a plurality of income sources of claim 10, wherein the method further identifies actions that can be taken by the person in order to ease the administration of the administration of the withdrawal plan.

14. The artificially intelligent retirement income planning method for determining and documenting a withdrawal plan for a person having a plurality of income sources of claim 10, wherein the method further uses a third strategy to calculate (a) a third withdrawal plan that results in the maximum or the pre-determined after-tax income being obtained during the withdrawal period; (b) a third report end net estate value resulting from the third withdrawal plan at report end date; and (c) a third life expectancy net estate value resulting from the third withdrawal plan at the person's life expectancy date.

15. The artificially intelligent retirement income planning method for determining and documenting a withdrawal plan for a person having a plurality of income sources of claim 10, wherein the first rule of the first strategy is to withdraw funds from the registered savings evenly from the retirement date until a pre-determined amount of time relative to the life expectancy date, or until a pre-determined age of the person, and the first rule of the second strategy is to withdraw funds from registered savings according to the base withdrawal plan.

16. The artificially intelligent retirement income planning method for determining and documenting a withdrawal plan for a person having a plurality of income sources of claim 10, wherein the income sources further include tax-free savings having a value.

17. (canceled)

18. (canceled)
